(19) United States
(12) Patent Application Publication
(10) Pub. No.: US 2025/0087893 A1
(43) Pub. Date: Mar. 13, 2025

(54) Spatial Modulator for Terahertz Radiation

(71) Applicant: The University of Manchester, Manchester (GB)

(72) Inventors: Coskun Kocabas, Manchester (GB); Muhammed Said Ergoktas, Manchester (GB); Yury Malevich, Manchester (GB); Gokhan Bakan, Manchester (GB)

(21) Appl. No.: 18/292,628

(22) PCT Filed: Jul. 26, 2022
(86) PCT No.: PCT/GB2022/051954

§ 371 Date: Jan. 26, 2024

(30) Foreign Application Priority Data
Jul. 27, 2021 (GB) 2110793.3

(51) Int. Cl. H01Q 15/00; G02F 1/29; H01Q 15/02

(52) U.S. Cl. CPC H01Q 15/002; G02F 1/292; H01Q 15/02

(57) ABSTRACT

There is provided a spatial modulator (100) for terahertz (THz) radiation. The spatial modulator (100) comprises a two-dimensional array of THz modulator pixels (200) having a layered structure. The layered structure of the two-dimensional array comprises an active matrix array (140) disposed on a back substrate layer (150) defining a two-dimensional array of back electrodes (321) of the THz modulator pixels; an electrolyte layer (130); a graphene top electrode (120), and a polymer outer layer (110) disposed on the graphene top electrode (120), wherein the polymer outer layer (110) is substantially transparent to THz radiation. The spatial modulator (100) further comprises control circuitry (400) configured to independently actively address the active matrix array (140) to control an applied voltage across each THz modulator pixel (200) to independently modulate one or more properties of each pixel in the THz region.

The present invention relates to a spatial modulator for radiation in the Terahertz (THz) region, to an imaging system comprising the spatial modulator, to a beam steering system comprising the spatial modulator, to a method of manufacturing the spatial modulator and to a method of modulating THz radiation.

### BACKGROUND

Terahertz (THz) radiation has a broad range of promising applications due to its non-ionizing nature and submillimetre wavelength. Applications include non-invasive spectroscopic imaging, biomedical diagnostics, product quality control and THz communication. Despite this promise, the THz region has been a relatively less utilised part of the electromagnetic spectrum as the THz region is a transition region between optics and electronics. Technologically, accessing this region has been very challenging, and is known as the “THz gap”. Conventional optical materials are not suitable for THz waves, and electronic devices cannot operate at THz frequencies. The lack of efficient THz electro-optical material has been a limiting factor hindering the realisation of THz devices.

Efforts to manipulate THz waves have yielded several successful demonstrations using active metamaterials, photoinduced charges, phase change materials and 2D crystals. Although results have been obtained at the single device level, system level integration that would enable scalable THz technologies remains a challenge due to the lack of an efficient THz material and integration scheme.

For particular applications, modulation of THz radiation may be used for THz imaging with a combination of a 2-dimensional spatial THz modulator, a single detector, and an image-reconstruction algorithm. However, due to the above-mentioned problems with scalable THz technologies limiting the resolution of THz spatial modulators, the resolution available for existing THz imaging is low.

It is an aim of the present invention to mitigate one or more of the problems associated with the prior art.

### BRIEF SUMMARY OF THE DISCLOSURE

In accordance with the present invention there is provided a spatial modulator, a method of manufacturing a spatial modulator, a method of spatially modulating terahertz radiation, an imaging system and a beam steering system as claimed in the appended claims.

According to a first aspect there is provided a spatial modulator for terahertz (THz) radiation, comprising a two-dimensional array of THz modulator pixels having a layered structure. The layered structure comprises an active matrix array disposed on a back substrate layer defining a two-dimensional array of back electrodes of the THz modulator pixels; an electrolyte layer; a graphene top electrode, and a polymer outer layer disposed on the graphene top electrode, wherein the polymer outer layer is substantially transparent to THz radiation. The spatial modulator comprises control circuitry configured to independently actively address the active matrix array to control an applied voltage across each THz modulator pixel to independently modulate one or more properties of each pixel in the THz region.

The active-matrix array may be a thin-film transistor (TFT) array comprising at least one thin-film transistor and at least one capacitor corresponding to each pixel. The control circuitry may be configured to actively address each TFT to control a charge accumulated on each capacitor, thereby controlling a charge on the back electrode and thus the voltage applied across each pixel. The TFT array may be fabricated from any semiconductor material such as amorphous silicon, low-temperature (LT) polycrystalline-silicon (LTPS), oxide semiconductors such as, zinc oxide indium gallium zinc oxide (IGZO), an organic semiconductor, or single crystal silicon. The control circuitry may comprise a silicon chip integrated on the TFT array (silicon-on-glass). The control circuitry may be configured to control the charge on each capacitor by varying a gate pulse duration for each thin-film transistor.

Optionally, the back electrodes of the THz modulator pixels are electrically isolated from each other. The back electrodes may be arranged to cover only a portion of each pixel. Each back electrode may be structured to provide polarisation of the THz radiation. For example, each back electrode may be structured to form a grating or a metamaterial.

In some embodiments, the back substrate layer comprises a flexible polymer substrate. Alternatively, other substrate materials suitable for the back substrate layer may comprise silicon or glass, for example.

Optionally, the electrolyte layer comprises a discontinuous layer of electrolyte. The electrolyte layer may comprise an isolated pocket of electrolyte corresponding to each pixel.

The graphene top electrode may comprise a common graphene layer over the two-dimensional array. The common graphene layer may comprise one or more graphene layers, e.g. monolayer, bilayer, or tri-layer graphene, for example. Between one and ten graphene layers may be used. Bilayer graphene beneficially provides uniformity without detracting from the efficiency of the electrolyte gating.

The polymer outer layer may comprise one or more of Polyethylene Terephthalate (PET), Polyethylene (PE), Polypropylene (PP), Polyimide (Kapton), Parylene and its derivatives.

Optionally, the control circuitry is configured to apply an additional bias voltage to the graphene top electrode.

In some embodiments, the applied voltage is selected to independently modulate transmitted THz radiation through each pixel. This may be referred to as a transmission mode. In transmission mode the electrolyte layer may have a thickness of less than a quarter wavelength of the THz radiation. For example, the electrolyte layer may have a thickness of less than 25 μm, such as between 5 μm and 10 μm. For example, the electrolyte layer may be substantially close to 5 μm thick.

In some embodiments, the applied voltage is selected to independently modulate reflected THz radiation from each pixel. This may be referred to as a reflection mode. In reflection mode, the applied voltage is selected to modulate one or both of a phase or intensity of the reflected THz radiation. In reflection mode, the electrolyte layer may have a thickness of between 1 μm and 500 μm. The polymer outer layer may have a thickness of between 1 μm to 500 μm.

According to another aspect there is provided an imaging system comprising: a source of THz radiation; a spatial modulator according to the above aspect configured to structure the THz radiation according to a predetermined modulation pattern; a THz detector configured to detect reflected THz radiation from an object; and a controller comprising one or more processors configured to determine image data indicative of the object in dependence on the detected THz radiation and the predetermined modulation pattern. In some embodiments, the spatial modulator is arranged to structure incident THz radiation before reflection from the object. In other embodiments, the spatial modulator is arranged to structure the reflected THz radiation.

According to another aspect there is provided a beam steering system for a THz communication protocol, comprising: a source of incident THz radiation; and a spatial modulator of the incident THz radiation according to the above aspect; wherein the spatial modulator is configured to modulate a phase of THz radiation reflected by each pixel in order to steer the reflected THz radiation to one or more active users of the THz communication protocol.

According to another aspect there is provided a method of manufacturing the spatial modulator as described in the above aspect, comprising: plasma treating a porous electrolyte host layer; laminating the porous electrolyte host layer onto the active matrix array; injecting an ionic liquid into the electrolyte host layer to form the electrolyte layer; laminating a multilayer film comprising the graphene top electrode, an adhesive and the polymer outer layer; and laminating the multilayer film on the electrolyte layer.

According to another aspect there is provided a method for spatially modulating terahertz (THz) radiation comprising: providing incident THz radiation on a two-dimensional array of THz modulator pixels, each pixel comprising a graphene top electrode, a back electrode and an electrolyte layer separating the top and back electrodes; and independently actively addressing an applied voltage across each THz modulator pixel using an active matrix array to independently modulate one or more properties of each pixel in the THz region.

### BRIEF DESCRIPTION OF THE DRAWINGS

Embodiments of the invention are further described hereinafter with reference to the accompanying drawings, in which:

FIG. 1 illustrates the layers of a THz spatial modulator 100 according to the present invention;

FIG. 2 illustrates an exploded and a cross-sectional view of a single modulator pixel 200 according to an embodiment;

FIG. 3 is a schematic illustration of a thin-film transistor (TFT) array 140 according to an embodiment of the invention;

FIG. 4 is a schematic illustration of the architecture of control circuitry 400 of the THz spatial modulator 100;

FIG. 5 illustrates an observed relationship between pixel voltage and gate pulse duration;

FIG. 6A illustrates a THz transmittance spectrum for a group of pixels 200 at two pixel voltages;

FIG. 6B illustrates the THz transmittance of the pixels 200 over time as the pixel voltage is changed;

FIG. 6C illustrates the THz transmittance spectrum for a group of pixels 200 at various pixel voltages between 0V and 5V;

FIG. 7A illustrates six spatial modulation patterns obtained using a spatial modulator 100 according to the invention;

FIG. 7B illustrates an effect of electrode separation on the modulation pattern observed;

FIG. 8A illustrates the reflected THz radiation deriving from the layers of the spatial modulator 100;

FIGS. 8B and 8C illustrate the effect of pixel voltage on the intensity and phase of reflected THz radiation according to first example data;

FIGS. 8D and 8E illustrate the effect of pixel voltage on the intensity and phase of reflected THz radiation according to second example data;

FIGS. 8F and 8G illustrate magnified portions of the data shown in FIG. 8E;

FIGS. 9A and 9B illustrate the effect of polymer outer layer thickness on the reflection spectrum of a modulator;

FIG. 10 illustrates a method of modulating THz radiation according to an embodiment;

FIG. 11 illustrates a method of manufacturing a THz spatial modulator according to an embodiment;

FIG. 12A illustrates an imaging system according to a first embodiment;

FIG. 12B illustrates an imaging system according to a second embodiment;

FIG. 13 illustrates example data captured using the imaging system of FIG. 12B to image metallic objects;

FIG. 14 shows a graph illustrating the X2 accuracy of the imaging system in the detection of metallic objects; and

FIG. 15 illustrates a beam steering system according to an embodiment.

### DETAILED DESCRIPTION

There is provided herein a THz spatial modulator according to an embodiment of the invention. The THz spatial modulator is scalable by design and thus may be fabricated according to some embodiments to a megapixel resolution with sub-wavelength pixels. Thus, the THz spatial modulator of embodiments of the present invention may be purposed to provide high-resolution THz imaging.

The scalability of the THz spatial modulator according to embodiments of the invention is achieved using active-matrix technology. Graphene operates as a tuneable THz absorber or reflector for the THz spatial modulator, enabling control of both transmission and reflection of THz radiation. Local THz reflectivity or transmittivity on the graphene can be controlled by an active-matrix electrode array defining a two-dimensional array of THz modulator pixels. The active-matrix configuration beneficially enables scalable control over a very large number of pixels, providing very large-scale integration (VLSI) of graphene THz modulator technology.

### Structure of THz Modulator

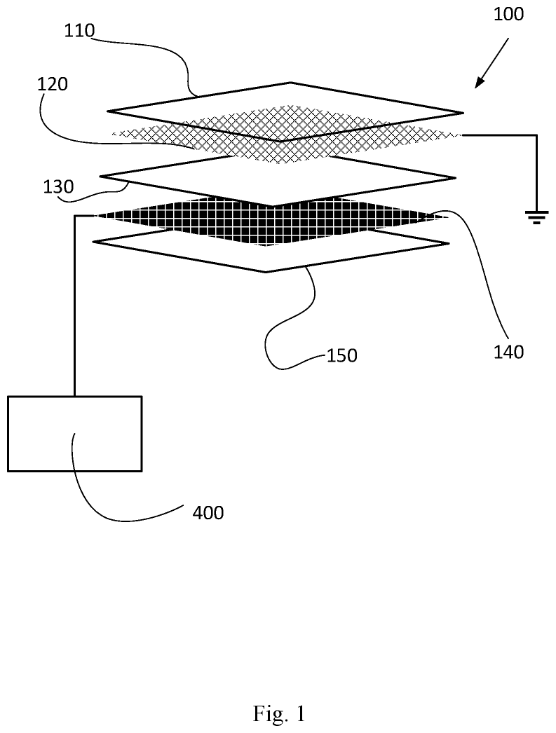

FIG. 1 shows a schematic illustration of a THz spatial modulator 100 according to an embodiment of the invention. It can be seen that the THz spatial modulator 100 has a layered structure, the layers 110, 120, 130, 140, 150 of which are shown exploded in FIG. 1 for ease of identification. The spatial modulator 100 comprises a two-dimensional array of THz modulator pixels, each of which may be individually addressed.

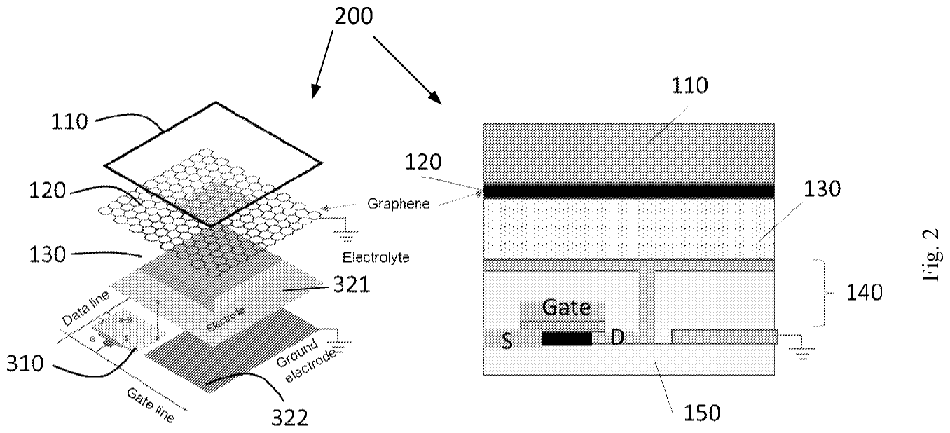

A schematic illustration of a single THz modulator pixel 200 of the spatial modulator 100 in both an exploded and a cross-sectional view according to an embodiment of the invention is shown in FIG. 2. Each individual THz modulator pixel 200 is structured in the layers of the spatial modulator 100, as explained below.

With reference to FIGS. 1 and 2, the spatial modulator 100 comprises a THz active layer 120 in the form of a graphene layer 120. The graphene layer 120 provides a graphene top electrode 120 for each modulator pixel 200. The spatial modulator 100 is configured to control the local charge density on each graphene top electrode 120 via electrolyte gating. By controlling the local charge density of the graphene top electrode 120 of each modulator pixel 200, one or more properties of THz radiation reflected or transmitted through the graphene layer 120 may be controlled, such as the intensity or phase of the THz radiation. By configuring the local charge density at the pixel level, the THz radiation may be spatially modulated.

The graphene layer 120 may be a common graphene layer. That is, the graphene layer 120 may be a continuous sheet of graphene over the array of modulator pixels rather than a discrete graphene electrode 120 for each modulator pixel 200. Advantageously this enables easier manufacturing. The graphene layer according to some embodiments may be monolayer or bilayer graphene, however more layers may be envisaged. The graphene layer 120 comprises bilayer graphene in an embodiment, as bilayer graphene beneficially provides uniformity without detracting from the efficiency of the electrolyte gating.

The spatial modulator 100 is provided with a polymer outer layer 110 disposed on the graphene layer 120. The material of the polymer outer layer 110 is selected to be substantially transparent to THz radiation. For example, suitable THz transparent materials include polyethylene terephthalate (PET), polyethylene (PE), polypropylene (PP), Parylene or Kapton. The polymer outer layer 110 acts to protect the graphene layer 120 and to modulate reflected THz radiation at the outer boundary of the graphene layer 120. The configuration of the polymer outer layer 110 and its role in modulating reflected THz radiation will be described in more detail later in relation to the reflection configuration of the THz spatial modulator.

The spatial modulator 100 comprises an electrolyte layer 130 for facilitating the electrolyte gating of the graphene layer 120. The electrolyte layer 130 separates the graphene top electrode 120 from a back electrode, such as electrode 321, of each modulator pixel 200. Thus the electrolyte layer 130 interposes the graphene top electrode 120 and the back electrode 321. The thickness of the electrolyte layer 130 may be tuned in dependence on the mode of operation of the spatial modulator 100, as will be explained later. In some embodiments, the electrolyte layer 130 is a common electrolyte layer, i.e. may comprise a continuous sheet of electrolyte across a plurality of pixels 200. In other embodiments, the electrolyte layer 130 may comprise a discontinuous layer of electrolyte. For example, the electrolyte layer 130 may comprise an isolated pocket of electrolyte corresponding to each pixel 200, which can beneficially reduce pixel crosstalk.

The spatial modulator 100 comprises an active matrix array layer 140 which defines a two-dimensional array of back electrodes 321 for the THz modulator pixels 200. The active matrix array layer 140 in an illustrated embodiment comprises a thin-film transistor (TFT) array 140.

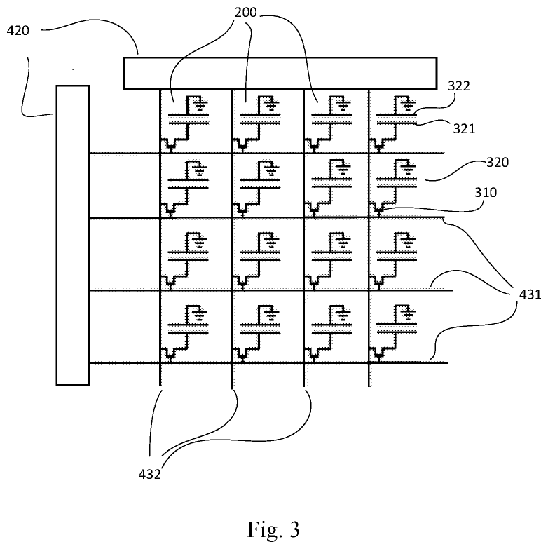

A thin-film transistor (TFT) array 140 according to an embodiment is schematically illustrated in FIG. 3. The TFT array 140 comprises a thin-film transistor (TFT) 310 and a capacitor 320 corresponding to each THz modulator pixel 200. The capacitor 320 defines a back electrode 321 of each pixel 200 and a ground electrode 322. The capacitor 320 is charged and discharged by the TFT 310, thereby controlling a charge accumulated on the back electrode 321. The charge accumulated on the back electrode controls the local conductivity on the graphene layer by electrolyte gating through the electrolyte layer 130. Control of the local conductivity on the graphene layer 120 at each pixel 200 defines the reflection or transmission of THz radiation at each pixel 200, facilitating spatial modulation of THz radiation.

The TFT array 140 may be fabricated from any suitable semiconductor material. Suitable TFT materials may include (but are not limited to) amorphous silicon, LT polycrystalline silicon (LTPS), IGZO, organic semiconductors, or single crystal silicon.

The TFT array 140 may be arranged such that the back electrodes 321 are electrically isolated from each other, thus facilitating independent control of the pixel voltages by active-matrix addressing as will be described. In some embodiments, the back electrodes 321 may be arranged such that the back electrode 321 covers only a portion of the area defined by each pixel 200. Reducing the coverage of the back electrode 321 may advantageously improve THz transmission, due to reduced attenuation by the back electrode 321 layer of the pixel. The reduction in coverage may be achieved by reducing a size of the back electrode 321, or by introducing one or more gaps in the back electrode. In particular, the back electrode 321 may be patterned or structured, which may beneficially aid in polarising the transmitted THz radiation. The structure of the back electrode 321 may for example be such that the back electrode forms a grating or other metamaterial.

With reference again to FIG. 1, the spatial modulator 100 further comprises control circuitry 400 for controlling the TFT array 140.

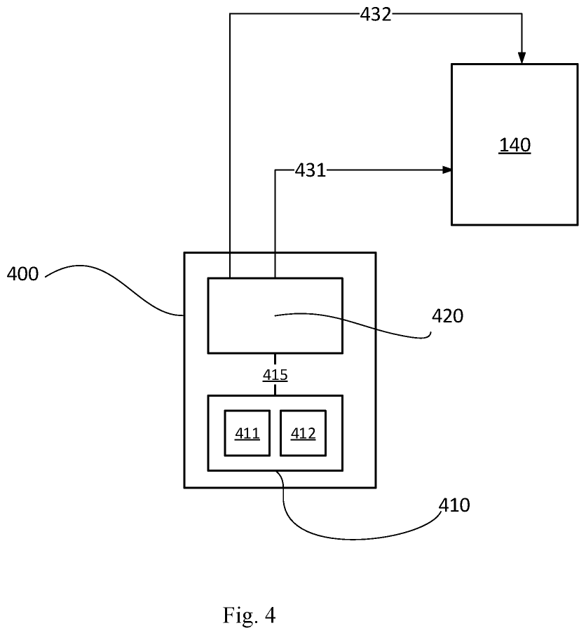

The architecture of the control circuitry 400 is illustrated schematically in FIG. 4. The control circuitry 400 is configured to actively address the pixels 200 of the TFT array 140 to independently or selectively modulate one or more properties of each pixel 200 in the THz region.

As discussed, the modulation of THz radiation at each pixel is defined by the charge accumulated on the back electrode 321 of each pixel 200. The control circuitry 400 is configured to control the charge accumulated on the back electrode 321 by actively addressing each TFT 310. In some embodiments, the control circuitry 400 comprises one or more driver circuits 420 configured to control the TFTs 310 of the array. The one or more driver circuits 420 may be implemented as one or more integrated circuits (ICs) integrated with the TFT array 140, for example as a chip-on-glass or silicon-on-glass controller 420.

With reference again to FIG. 3, the one or more driver circuits 420 are configured to scan the voltages applied to rows 431 and columns 432 of the TFT array 140. The rows 431 control a gate voltage of each TFT 310 and the columns 432 control a drain voltage of each TFT 310. This scanning of voltages on the rows 431 and columns 432 of the TFT array 140 may be referred to as active matrix addressing. The active matrix addressing scheme enables individually controlled pixels in a very large array, which provides scalability to the spatial modulator 100. By controlling the gate voltage and drain voltage of each TFT 310, the driver circuit 420 consequently controls the charge accumulated on the back electrode 321 and thus the voltage applied across the pixel 200. The one or more driver circuits 420 may control the charge accumulated on the back electrode using a number of active-matrix addressing mechanisms to scan the voltages of the TFT array 140. In particular embodiments the driver circuit 420 may vary the gate voltage, vary the drain voltage, and/or vary a gate pulse duration. The gate pulse duration is a duration or period of time to which a voltage is applied to the gate of each TFT 310.

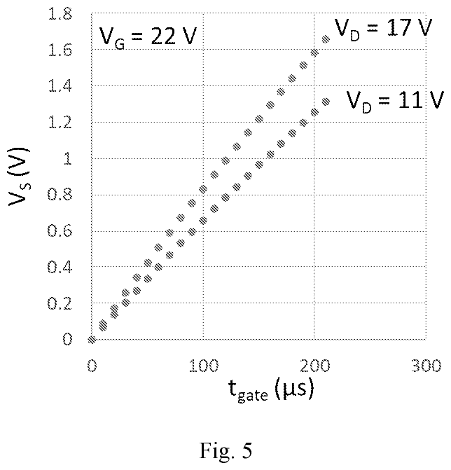

With reference to FIG. 5, varying the gate pulse duration whilst keeping the gate and drain voltages constant beneficially provides a linear relationship with the resultant pixel voltage across the pixel 200. FIG. 5 illustrates the relationship between the pixel voltage (y-axis) and the gate pulse duration (x-axis) as controlled by the driver circuit 420, at a constant gate voltage of 22V and for two drain voltages 11V and 17V. As can be seen, the drain voltage impacts the gradient of the linear relationship between the gate pulse duration and the pixel voltage.

According to some embodiments, the control circuitry 400 is connected to a common electrode in contact with the graphene layer 120. The driver circuit 420 may be configured to apply an additional bias voltage to the graphene layer 120 via the common electrode. The application of an additional bias voltage acts beneficially to compensate for a shift of the Dirac point due to unintentional doping of the graphene during the fabrication process. The additional bias voltage applied may vary dependent on the materials used to fabricate the spatial modulator 100, as will be appreciated. In some embodiments, the additional voltage is less than 5V, such as 2V or 3V.

Returning to FIG. 4, the control circuitry 400 may in some embodiments comprise one or more controllers 410 configured to control the spatial modulation pattern for the spatial modulator 100. The one or more controllers 410 may comprise one or more external microcontrollers 410 communicably coupled to the driver circuit 420. In other embodiments, the one or more controllers 410 may comprise an external computing device such as a PC, laptop or mobile computing device such as a mobile phone or tablet. Each controller 410 comprises at least one processor 411 and at least one memory device 412. The at least one memory device 412 is configured to store computer-readable instructions which when executed cause the at least one processor 411 to generate at least one modulation pattern for the spatial modulator 100. That is, the controller 410 may be configured to determine a 2D modulation pattern for the pixels 200 of the spatial modulator 100. In some embodiments, a plurality of modulation patterns may be used and the controller 410 may selectively apply each modulation to the pixels. The controller may be configured to transmit a control signal 415 to the driver circuit 420 which causes the driver circuit to address the TFT array 140 to produce the generated modulation pattern.

With reference again to FIGS. 1 and 2, the TFT array 140 is fabricated on a back substrate layer 150. According to some embodiments, the back substrate layer 150 comprises a flexible polymer substrate. Advantageously, fabricating the TFT array 140 on a flexible polymer substrate layer 150 enables the fabrication of a flexible THz spatial modulator 100. In other embodiments, the TFT array 140 may be fabricated on any suitable back substrate 150 such as silicon or glass. In some embodiments wherein the spatial modulator 100 is arranged to modulate transmitted THz radiation, it is preferred that the back substrate layer 150 is substantially THz transparent.

The spatial modulator 100 may be differently configured to optimise THz modulation in either a reflection or transmission mode.

### Transmission Mode

The pixel voltage, as discussed above, may be selected in order to modulate an intensity of transmitted THz radiation through each pixel 200. A spatial modulator 100 arranged to modulate transmitted THz radiation may be referred to as operating in a transmission mode.

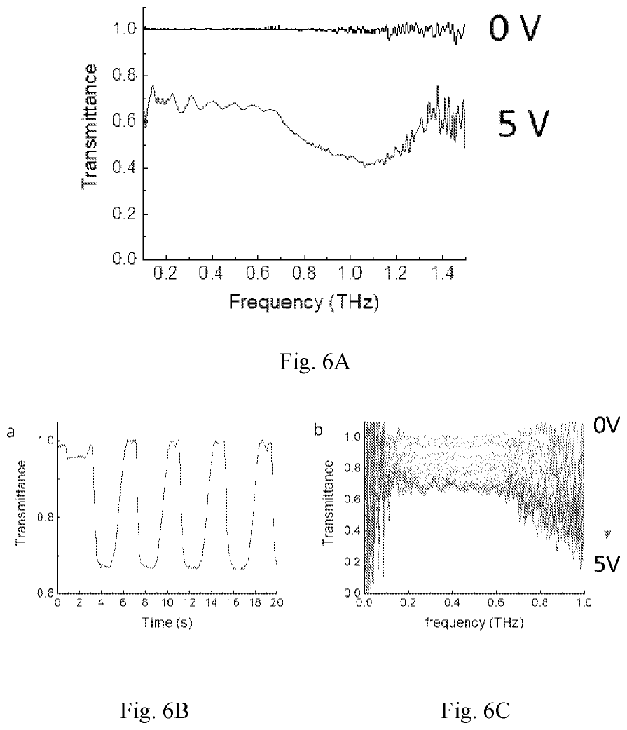

FIG. 6A illustrates a measured THz transmittance spectrum for a group of pixels 200 at two different applied voltages, such as 0V and 5V, uniformly applied across all pixels 200. As shown, applying a voltage across each pixel 200 effectively reduces the transmittance of broadband THz radiation across the shown spectral range from 0.1 THz to 1.5 THz.

FIG. 6B illustrates time dependent modulation of THz transmittance through the same group of pixels 200, when a square wave voltage is applied across the pixels 200. FIG. 6C illustrates the corresponding shift in THz frequency spectra across a plurality of time points of FIG. 6B.

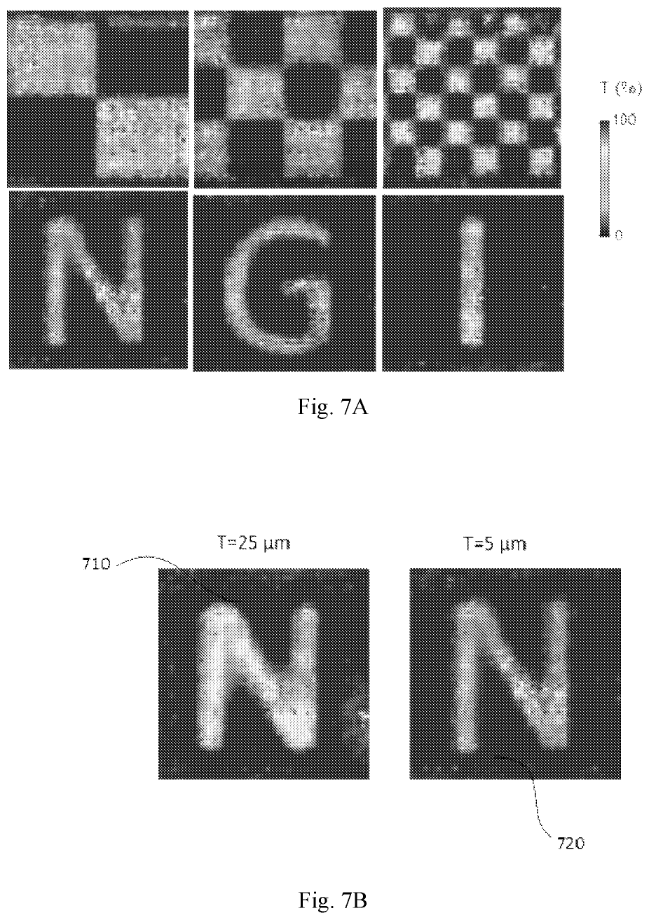

FIG. 7A illustrates six spatial modulation patterns obtained using a spatial modulator 100 according to the invention having 400 columns and 600 rows. Active-matrix addressing was utilised to apply a voltage independently to each pixel 200, to independently control the THz transmission through each pixel 200 of the modulator 100. The images shown were recorded by a THz imaging device having a 64×64 array of THz detectors through the THz spatial modulator 100 at 0.1 THz frequency.

Various modifications may be made to the spatial modulator 100 to improve the performance of modulating transmitted THz radiation. In particular, the back substrate layer 150 can be selected to be THz transparent, as discussed, in order to reduce attenuation of the transmitted THz radiation by the lower layers of the modulator 100. Furthermore, the back electrode 321 defined by the TFT array 140 may be arranged to be THz transparent or to have a reduced area as discussed previously to allow transmitted THz radiation to penetrate.

For a spatial modulator 100 configured in a transmission mode, the specific thicknesses of the layers illustrated in FIG. 1 are not critical, in contrast to modulation of reflected THz radiation which will be discussed below. However, resolution of the spatial modulation can be improved in transmission mode by minimising the separation between the graphene layer 120 and the back electrode 321, in order to reduce the crosstalk between the pixels 200.

FIG. 7B illustrates the effect of reducing the separation between the graphene layer 120 and the back electrode 321 on the resolution of spatial modulation in transmission mode. The separation may be reduced by reducing the thickness of the electrolyte layer 130. FIG. 7B shows a first image 710 taken using a spatial modulator 100 with a first separation of 25 μm, and a second image 720 taken using a spatial modulator 100 with a second separation of 5 μm. It will be realised that the separations are merely examples and embodiments of the invention are not limited to these distances. The same pixel voltages have been applied in each image. It can be seen that the second image 720 has a notably sharper resolution.

To achieve a higher resolution, the electrolyte layer 130 may be arranged to have a thickness of less than a quarter wavelength of the THz radiation, e.g. less than 25 μm. As shown in FIG. 7B, improved resolution can be observed by providing a spatial modulator 100 having an electrolyte layer 130 of thickness between 4 and 10 μm, such as a thickness of 5 μm or 6 μm, for example.

### Reflection Mode

The pixel voltage may be selected in order to modulate an intensity and/or a phase of reflected THz radiation from each pixel 200. A spatial modulator 100 arranged to modulate reflected THz radiation may be referred to as operating in a reflection mode.

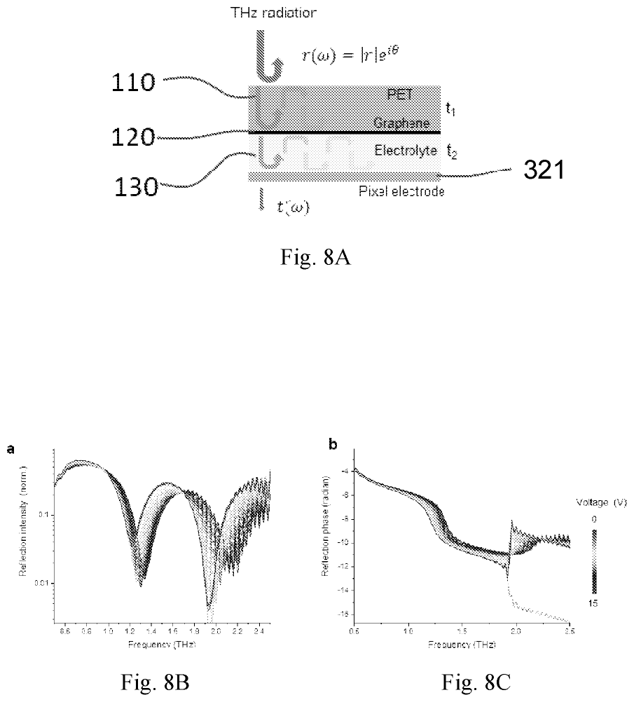

The layered structure of the spatial modulator 100 facilitates strong resonances in the reflectivity of THz radiation. FIG. 8A illustrates the contribution to the reflected THz radiation deriving from the interfaces between the layers of the spatial modulator 100. As can be seen in FIG. 8A, a first reflection component arises from the interface between the air and the polymer outer layer 110, a second reflection component from the graphene layer 120, and a third reflection component from the interface between the electrolyte layer 130 and the bottom electrode 321. It will be appreciated that there are other small reflections from the other layers such as the back substrate layer 150 however the contributions are not significant. When the pixels are addressed to apply a voltage across the pixel 200, the conductivity of the graphene layer 120 changes resulting a shift in the resonance frequency of the pixel 200, enabling both modulation of intensity and phase of the reflected THz radiation.

FIGS. 8B and 8C illustrate resultant reflected THz radiation when a square wave voltage between 0V and 15V was applied to all pixels 200 of a spatial modulator 100. A time domain THz spectrometer which can measure both intensity and phase of the THz waves was used to measure the THz radiation reflected from a spatial modulator 100 in the reflection mode.

FIG. 8B shows the intensity of the reflected radiation (y-axis) against the frequency of the reflected radiation (x-axis). The multiple lines on the plot indicate the spectrum at different applied voltages between 0V and 15V.

FIG. 8C shows the phase of the reflected radiation (y-axis) against the frequency of the reflected radiation (x-axis). The multiple lines on the plot indicate the spectrum at different applied voltages between 0V and 15V.

As can be seen, the multilayer structure of the spatial modulator 100 provides multiple resonance frequencies. When a voltage is applied across the pixel 200, the resonance frequency shifts due to the conductivity change of the graphene layer 120. Because of the shift in the resonance frequency, both intensity and phase modulation is obtained.

As the resonance absorption of THz radiation depends on the interference of the reflected components from different layers of the spatial modulator, the thickness of the polymer outer layer 110 and the electrolyte layer 130 is important. The thickness of each of the polymer outer layer 110 and electrolyte layer 130 can be selected to obtain resonance at desired frequencies of the THz spectrum.

FIGS. 8D to 8G show further example data obtained from a second spatial modulator 100. As with FIGS. 8B and 8C, a square wave voltage between 0 to 15 V was applied to all pixels of the second spatial modulator 100 and the intensity and phase of the reflected THz radiation was measured to obtain the illustrated data.

FIG. 8D shows the intensity of the reflected radiation (y-axis) against the frequency of the reflected radiation (x-axis). The multiple lines on the plot indicate the spectrum at different applied voltages between 0V and 15V.

FIG. 8E shows the phase of the reflected radiation (y-axis) against the frequency of the reflected radiation (x-axis). The multiple lines on the plot indicate the spectrum at different applied voltages between 0V and 15V.

At low voltages, FIG. 8D illustrates that there are two resonant frequencies for the spatial modulator 100 at around 1.5 THz and 2.4 THz. As the voltage applied is increased, there is a transition from two resonance frequencies to one resonance frequency, along with a shift in the resonance frequency. This shift in the resonance frequency also causes a phase shift in the reflected light, as shown in FIG. 8E.

As well as the gradual phase shift, a sharp step-like phase modulation is achieved above each resonance frequency at a threshold voltage. FIG. 8F shows a magnified portion of the phase plot of FIG. 8E to illustrate the step-like phase modulation above the first resonance frequency at ˜1.5 THz. Above the first resonance frequency, a 2π phase shift of the reflected light is achieved by increasing the voltage of applied to the pixel. FIG. 8G shows the same phenomenon above the second resonance frequency at ˜2.4 THz. Above the second resonance frequency, two step-like changes occur, each causing a 2π phase shift.

This step-like phase modulation is a result of a change in reflection topology of the spatial modulator 100. Increasing the applied voltage above the threshold voltage thus acts as a topological switch. The reflection topology can only have discrete values and so a switch in the reflection topology causes a step-like change in phase at frequencies above the resonance. Above the second resonance frequency, two step-like changes are possible, one originating at each resonance frequency. Thus, a phase spread of 4π radians is observed. For a further explanation of the physics of the topological switching, reference is made to “Topological engineering of terahertz light using electrically tunable exceptional point singularities”, Ergoktas et al, Science 376, 184-188, 8 Apr. 2022.

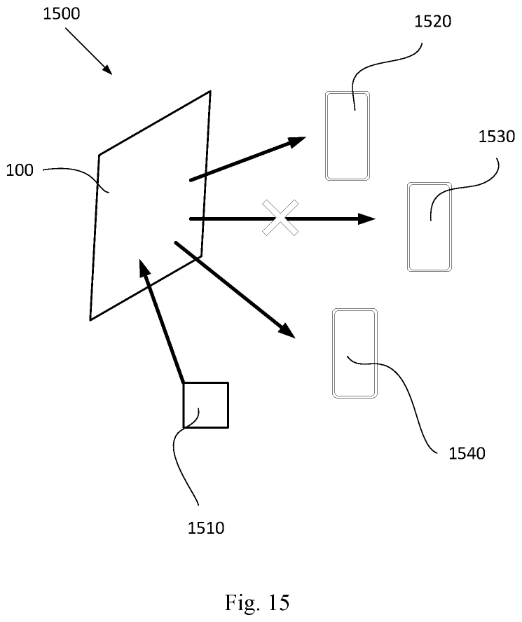

Notably, this modulation of intensity and phase of reflected radiation can be controlled at the pixel level on the spatial modulator 100. Thus, the voltage across each pixel can be individually addressed to achieve a desired phase across a full phase range. Thus, the spatial modulator 100 can be used as a phased array to control a direction of the reflected light, as will be described further with reference to FIG. 15.

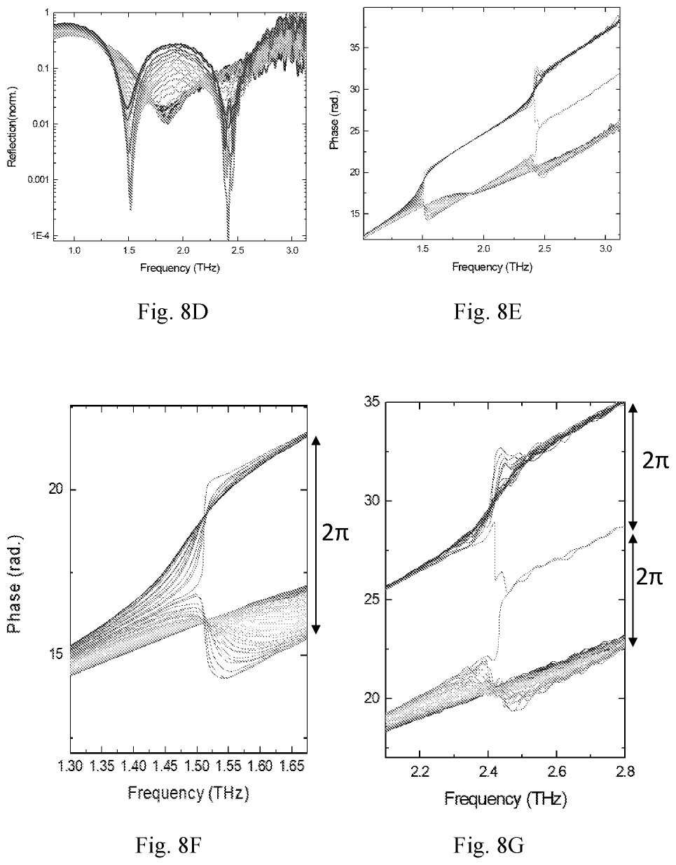

FIGS. 9A and 9B illustrate the effect of the thickness of the polymer outer layer 110 on the resonance frequencies of the modulator. FIG. 9A illustrates a reflection spectrum from a modulator having a 90 μm thick polymer outer layer 110. It can be seen that resonance absorption is provided around the 1.2 THz and 1.9 THz frequencies. FIG. 9B illustrates a reflection spectrum from a modulator having a 75 μm thick polymer outer layer 110. It can be seen that resonance absorption is provided around 1.5 THz and 2.5 THz. These resonance frequencies are periodic at multiple or half multiple frequencies of the first resonances. Depending on the thickness and the refractive index of the polymer outer layer 110, the locations of the resonances can be adjusted.

### Method of Modulating THz Radiation

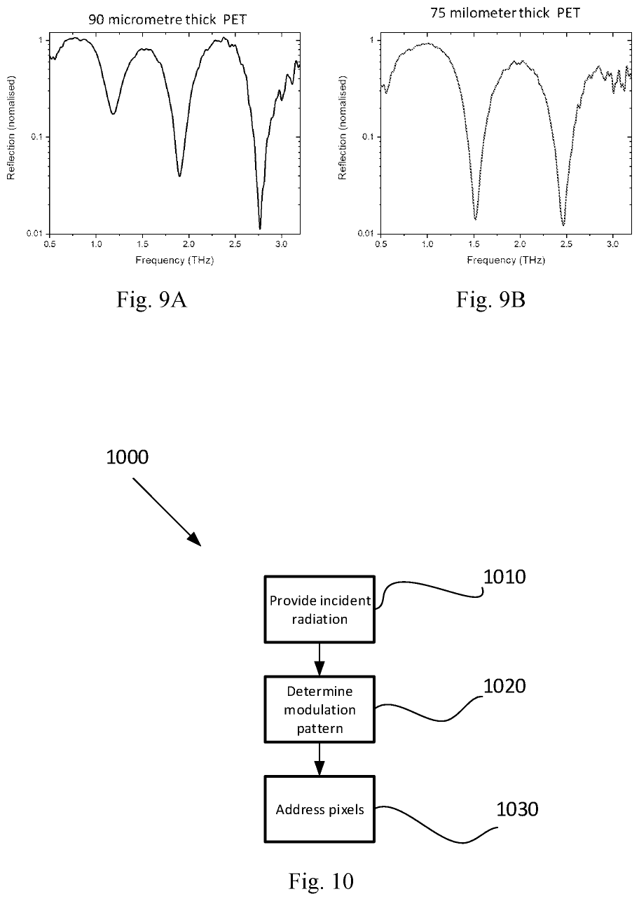

FIG. 10 illustrates a method 1000 of spatially modulating THz radiation according to an embodiment of the invention. The method 1000 is performed using the spatial modulator 100.

The method 1000 comprises a step 1010 of providing incident THz radiation. The incident radiation may have any spectrum including THz wavelengths, such as broadband THz radiation, or a tailored THz spectrum comprising selected wavelengths. The THz radiation is provided to be incident on a two-dimensional array of THz modulator pixels 200, such as provided by the spatial modulator 100.

The method 1000 comprises a step 1020 of determining spatial pattern data for the modulation. The spatial pattern data may be determined by the one or more controllers 410 in dependence on data stored in the memory 412 or in dependence on a user input such as through one or more user interfaces. The spatial pattern data is indicative of a desired modulation pattern for the spatial modulator, that is a desired transmission or reflection spectra for each pixel 200, depending on whether the spatial modulator 100 is in a reflection or transmission configuration. In some embodiments, the spatial pattern data may be indicative of a voltage to be applied across each pixel 200.

The method 1000 comprises a step 1030 of independently actively addressing an applied voltage across each THz modulator pixel 200 according to the spatial pattern data. By adjusting the voltage across each pixel 200, as has been explained, reflectance or transmittivity of each pixel in the THz region can be independently modulated, to obtain the desired modulation pattern.

### Method of Manufacture of THz Spatial Modulator

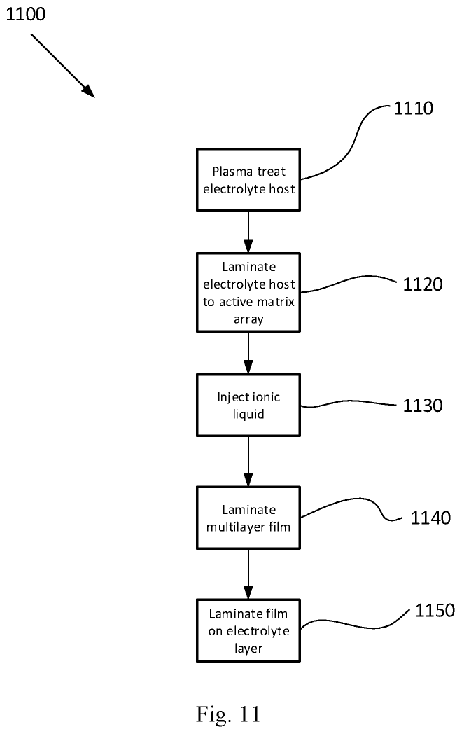

FIG. 11 illustrates a method 1100 of manufacturing the spatial modulator 100 according to an embodiment.

The method 1100 comprises a step 1110 of plasma treating a porous electrolyte host layer. The porous electrolyte host layer may comprise any suitable substrate for receiving an ionic liquid to form the electrolyte layer 130. In some embodiments, the porous electrolyte host layer comprises a polymer grid defining pockets for the electrolyte, in embodiments wherein the electrolyte layer 130 is configured to be discontinuous. Plasma treating the porous electrolyte host layer advantageously helps the layer to subsequently adhere to the graphene layer 120.

The method 1100 comprises a step 1120 of laminating the porous electrolyte host layer onto the active matrix array. The active matrix array comprises the TFT array 140 prefabricated on the back substrate layer 150.

The method 1100 comprises a step 1130 of injecting ionic liquid into the porous electrolyte host layer to form the electrolyte layer 130. The ionic liquid may be injected to substantially fill the electrolyte host layer. In other embodiments, the ionic liquid may be injected into preformed pockets to provide an electrolyte layer 130 comprising discrete pockets of electrolyte for each pixel 200.

The method 1100 comprises a step 1140 of laminating a multilayer film to form an upper portion of the spatial modulator 100. The multilayer film comprises the graphene top electrode, an adhesive layer over the graphene top electrode, and the polymer outer layer 110. The adhesive layer ensures that the polymer outer layer affixes sufficiently to the graphene top electrode during the lamination of the film.

The method 1100 comprises a step 1150 of laminating the multilayer film forming the upper portion of the spatial modulator onto the electrolyte layer 130 such that the graphene layer 120 and the electrolyte layer 130 adhere. The previous plasma treatment of the electrolyte host layer in step 1110 ensures that the lamination is robust.

### Imaging System

The spatial modulator 100 according to the present invention may be utilised to produce a high resolution THz imaging system.

Generally, a THz imaging system can be constructed either via direct imaging using a focal plane detector array or via computational imaging using a single detector with a modulator array. The present invention provides an efficient spatial modulator 100 for realising the second type of imaging system.

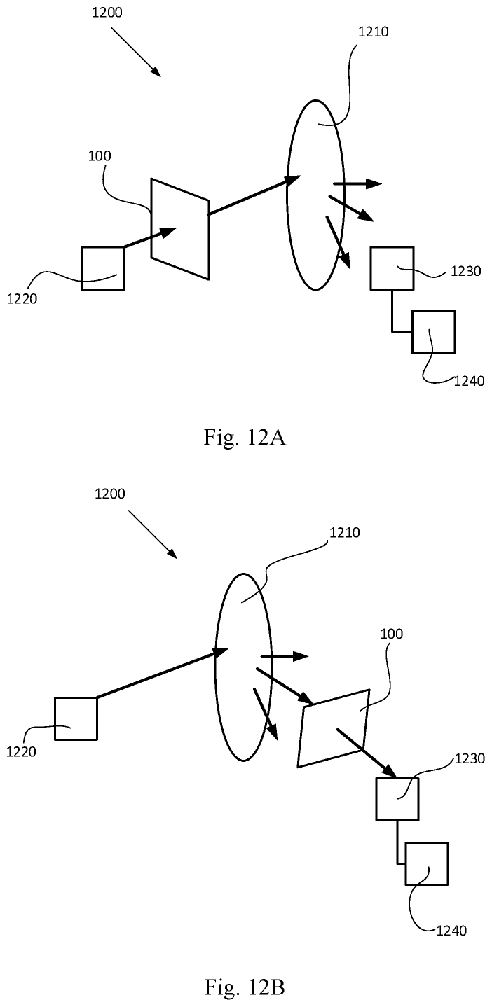

FIGS. 12A and 12B illustrate two configurations of a THz imaging system 1200 according to an embodiment of the invention. The THz imaging system 1200 may be utilised for THz imaging applications, such as in body scanners. The THz imaging system 1200 is used to image an object 1210.

The THz imaging system 1200 comprises a source 1220 of THz radiation. The source 1220 may be configured to provide broadband THz radiation. The THz radiation is provided incident on the object 1210 to be imaged, and the object 1210 reflects the incident THz radiation to produce reflected THz radiation. The THz imaging system 1200 comprises a detector 1230 for detecting the reflected THz radiation. In some embodiments, the detector 1230 comprises a single-pixel sensor.

The THz imaging system 1200 comprises a spatial modulator 100 according to the present invention. The spatial modulator 100 is arranged in transmission mode, i.e. to modulate the intensity of transmitted THz radiation. The spatial modulator 100 is utilised to structure the transmitted THz radiation according to a predetermined modulation pattern. In a first embodiment shown in FIG. 12A, the spatial modulator 100 is arranged to structure the THz radiation incident on the object 1210. In a second embodiment shown in FIG. 12B, the spatial modulator 100 is arranged to structure the THz radiation reflected from the object.

The THz imaging system 1200 comprises a controller 1240 communicably coupled to the detector 1230. The controller 1240 comprises one or more processors and a memory comprising computer-readable instructions which when executed, cause the one or more processors to perform an image processing method. The controller 1240 is configured to receive detection data from the detector 1230 and determine image data indicative of the object in dependence on the detection data and the predetermined modulation pattern. By changing the predetermined modulation pattern and measuring, at the detector 1230, a series of reflected intensities, spatial information of the object 1210 may be reconstructed by the controller 1240 utilising a suitable image reconstruction algorithm such as a compressed sensing algorithm (also known as a compressive sensing, compressive sampling or sparse sampling algorithm).

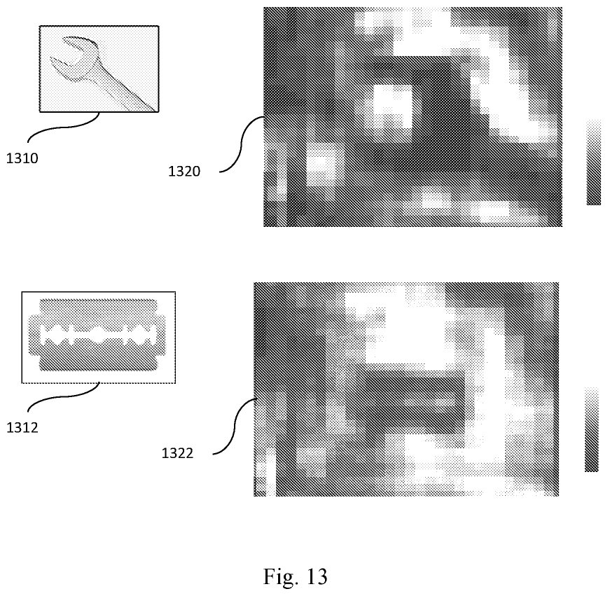

FIG. 13 shows example imaging data obtained by using the THz imaging system 1200 illustrated in FIG. 12B. The THz imaging system was utilised to identify metallic objects. In the illustrated data, two metallic objects were imaged, a wrench 1310 and a blade 1312. Each metallic object 1310, 1312 was placed between the THz source 1220 and the spatial modulator 100. The intensity of the THz radiation transmitted through the spatial modulator 100 was collected using a single-pixel detector 1230. A plurality of modulation patterns, or masks, were applied to the spatial modulator 100 and a respective intensity measurement was recorded at the detector 1230 for each mask.

An image can thus be reconstructed for each object using an imaging algorithm as described in “Terahertz compressive imaging with metamaterial spatial light modulators”, Watts et al, Nature Photonics, Vol 8, August 2014. A first image 1320 was in this way acquired of the wrench 1310 and a second image 1322 was acquired of the blade 1312. It can be seen in FIG. 13 that the shape of each metallic object 1310, 1312 is visible in the respective reconstructed image 1320, 1322.

To achieve the images shown in FIG. 13, 1000 masks (modulation patterns) were applied to the spatial modulator 100. However, fewer masks may be utilised without a significant drop in image reconstruction accuracy.

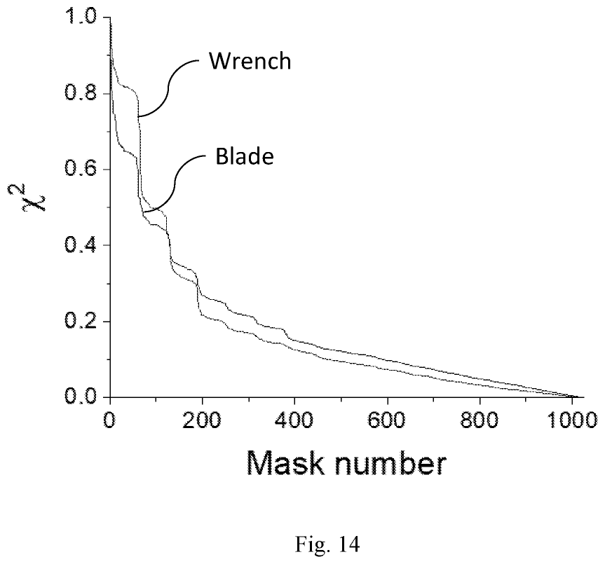

FIG. 14 illustrates the effect of the number of masks used on the error of the reconstructed image (parameterised as a X2 value) for each of the wrench and the blade. The number of masks is shown along the x-axis and the resultant X2 value for each image is shown along the y-axis. A theoretical maximum of 1024 masks can be used to achieve a 32×32 image. This resolution is limited by the wavelength of the radiation and thus additional masks would cause no further increase in accuracy. Although increasing the mask number to this theoretical maximum minimises the error, sufficiently high accuracy can be achieved even with a lower number of masks, e.g., around 400 masks. Reducing the number of masks reduces the amount of data collected and thus improves the speed and efficiency of the imaging.

### Beam Steering System

The spatial modulator 100 according to the present invention may be utilised to produce a beam steering system. The beam steering system may be used for a THz communication protocol or for THz imaging, such as in the THz imaging system 1200.

FIG. 15 illustrates a beam steering system 1500 according to the present invention for a THz communication protocol. The beam steering system 1500 comprises a source 1510 of incident THz radiation for providing a communication channel. The beam steering system 1500 is configured to provide the THz radiation for the communication protocol to a plurality of client mobile devices 1520, 1530, 1540. As a power level of THz sources such as the source 1510 may be limited, it can be important to direct the signal selectively to active users. In FIG. 15, mobile devices 1520 and 1540 are shown as active users and mobile device 1530 is shown as inactive.

The source 1510 provides incident THz radiation on a spatial modulator 100 as shown. The spatial modulator 100 is configured in the reflection mode to spatially modulate a phase of THz radiation reflected by each pixel 200 in order to steer the reflected THz radiation to the active mobile devices 1520 and 1540. The steering is achieved via periodic modulation of the phase of the reflected THz radiation. Advantageously, the spatial modulator 100 may be fabricated with subwavelength pixels which can enable a very large beam steering angle. As illustrated in FIGS. 8B through 8G, the spatial modulator according to the present invention can modulate the phase of each pixel over a full range by controlling the voltage on each pixel, thus providing fine control over the direction of the reflected radiation.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A spatial modulator for terahertz (THz) radiation, comprising:
a two-dimensional array of THz modulator pixels having a layered structure comprising:
an active matrix array disposed on a back substrate layer defining a two-dimensional array of back electrodes of the THz modulator pixels;
an electrolyte layer;
a graphene top electrode, and
a polymer outer layer disposed on the graphene top electrode, wherein the polymer outer layer is substantially transparent to THz radiation; and
control circuitry configured to independently actively address the active matrix array to control an applied voltage across each THz modulator pixel to independently modulate one or more properties of each pixel in the THz region.

2. The spatial modulator of claim 1, wherein the active-matrix array is a thin-film transistor (TFT) array comprising at least one thin-film transistor and at least one capacitor corresponding to each pixel,
and wherein the control circuitry is configured to actively address each TFT to control a charge accumulated on each capacitor, thereby controlling a charge on the back electrode and thus the voltage applied across each pixel.

3. The spatial modulator of claim 2, wherein the control circuitry is configured to control the charge on each capacitor by varying a gate pulse duration for each thin-film transistor.

4. The spatial modulator of claim 1, wherein the back electrodes of the THz modulator pixels are electrically isolated from each other.

5. The spatial modulator of claim 1, wherein the back electrodes are arranged to cover only a portion of each pixel.

6. The spatial modulator of claim 5, wherein each back electrode is structured to provide polarisation of the THz radiation.

7. The spatial modulator of claim 6, wherein each back electrode is structured to form a grating or a metamaterial.

8. The spatial modulator of claim 1, wherein the back substrate layer comprises a flexible polymer substrate.

9. The spatial modulator of claim 1, wherein the electrolyte layer comprises a discontinuous layer of electrolyte.

10. The spatial modulator of claim 1, wherein the graphene top electrode comprises a common graphene layer over the two-dimensional array.

11. The spatial modulator of claim 10, wherein the common graphene layer comprises between one and ten graphene layers, optionally wherein the common graphene layer comprises bilayer graphene.

12. The spatial modulator of claim 1, wherein the polymer outer layer comprises one or more of Polyethylene Terephthalate (PET), Polyethylene (PE), Polypropylene (PP), Polyimide (Kapton) or Parylene.

13. The spatial modulator of claim 1, wherein the control circuitry is configured to apply an additional bias voltage to the graphene top electrode.

14. The spatial modulator of claim 1, wherein the applied voltage is selected to independently modulate transmitted THz radiation through each pixel.

15. The spatial modulator of claim 14, wherein the electrolyte layer has a thickness of less than a quarter wavelength of the THz radiation.

16. The spatial modulator of claim 1, wherein the applied voltage is selected to independently modulate reflected THz radiation from each pixel.

17. The spatial modulator of claim 16, wherein the electrolyte layer has a thickness of between 1 μm and 500 μm.

18. The spatial modulator of claim 16, wherein the polymer outer layer has a thickness of 1 μm to 500 μm.

19. An imaging system comprising:
a source of THz radiation;
a spatial modulator according to claim 1 configured to structure the THz radiation according to a predetermined modulation pattern;
a THz detector configured to detect reflected THz radiation from an object; and
a controller comprising one or more processors configured to determine image data indicative of the object in dependence on the detected THz radiation and the predetermined modulation pattern.

20. A beam steering system for a THz communication protocol, comprising:
a source of incident THz radiation; and
a spatial modulator of the incident THz radiation according to claim 16;
wherein the spatial modulator is configured to modulate a phase of THz radiation reflected by each pixel in order to steer the reflected THz radiation to one or more active users of the THz communication protocol.

21. A method of manufacturing the spatial modulator of claim 1, comprising:
plasma treating a porous electrolyte host layer;
laminating the porous electrolyte host layer onto the active matrix array;
injecting an ionic liquid into the electrolyte host layer to form the electrolyte layer;
laminating a multilayer film comprising the graphene top electrode, an adhesive and the polymer outer layer; and
laminating the multilayer film on the electrolyte layer.

22. A method for spatially modulating terahertz (THz) radiation comprising:
providing incident THz radiation on a two-dimensional array of THz modulator pixels, each pixel comprising a graphene top electrode, a back electrode and an electrolyte layer separating the top and back electrodes; and
independently actively addressing an applied voltage across each THz modulator pixel using an active matrix array to independently modulate one or more properties of each pixel in the THz region.
